(19) United States
(12) Patent Application Publication
(10) Pub. No.: US 2011/0094112 A1
(43) Pub. Date: Apr. 28, 2011

(54) SERRATED HOOK BLADE

(76) Inventor: Jeff PATTERSON, Verona, CA (US)

(21) Appl. No.: 12/868,543

(22) Filed: Aug. 25, 2010

Related U.S. Application Data
(60) Provisional application No. 61/236,700, filed on Aug. 25, 2009.

(51) Int. Cl. B26B 9/02

(52) U.S. Cl. 30/355

(57) ABSTRACT

A hook-shaped knife blade is provided having a curved sharpened inside edge, the sharpened edge comprising a plurality of serrations. The plurality of serrations abut each other to form a plurality of points where adjacent serrations abut, and each serration has an arc-shaped scallop forming a portion of the sharpened edge. The serrations move material away from the leading edge of the blade, thereby keeping the edge cleaner and providing a longer usable blade life. Moreover, the points provide localized pressure on the material when starting a cut, enabling better penetration into the material, while each serration acts as a mini-hook blade, forcing the material to be cut into the curve instead of pushing it away.

### RELATED APPLICATIONS

The present application claims priority from U.S. Provisional Patent Application No. 61/236,700, filed Aug. 25, 2009, and hereby incorporates by reference the disclosure thereof in its entirety.

### TECHNICAL FIELD

The present disclosure relates to knife blades. The present disclosure has particular applicability to hooked blades, as used for cutting roofing shingles.

### BACKGROUND ART

Conventional blades for hand-held knives for cutting roofing materials such as shingles and tar paper (and also for cutting tiles, rope, cloth, etc.) typically are hook-shaped, and have a curved sharpened edge inside the hook. Such conventional blades can easily lose their bite and “skitter” across the top of roofing tiles. Also, conventional blades tend to dull and wear out easily when cutting hard materials. There exists a need for a hook blade with improved grip and wear characteristics.

### SUMMARY

The teachings herein provide a serrated hook-shaped blade which exhibits superior grip, and stays sharp longer.

According to the present disclosure, the foregoing and other advantages are achieved in part by a hook-shaped knife blade having a curved sharpened inside edge, the sharpened edge comprising a plurality of serrations. The plurality of serrations abut each other to form a plurality of points where adjacent serrations abut, and each serration has an arc-shaped scallop forming a portion of the sharpened edge.

Additional advantages and other features of the present disclosure will be set forth in part in the description which follows and in part will become apparent to those having ordinary skill in the art upon examination of the following or may be learned from the practice of the invention. The advantages of the disclosure may be realized and obtained as particularly pointed out in the appended claims.

### BRIEF DESCRIPTION OF THE DRAWINGS

Reference is made to the attached drawings, wherein elements having the same reference numeral designations represent like elements throughout, and wherein:

FIG. 1a is a front view of a serrated hook blade according to an embodiment of the present disclosure;

FIG. 1b is a cross-sectional view of the disclosed blade taken through line B-B of FIG. 1a;

FIG. 1c is a detail of area C of FIG. 1a;

FIG. 2a is another front view of the serrated hook blade according to an embodiment of the present disclosure;

FIG. 2b is a cross-sectional view of the disclosed blade taken through line B-B of FIG. 2a;

FIG. 2c is a cross-sectional view of the disclosed blade taken through line C-C of FIG. 2a.

### DETAILED DESCRIPTION

One exemplary embodiment of a serrated hook blade according to the present disclosure is for use with a standard utility knife. It should be understood, however, that other types of knives are usable with the blade of this disclosure; that is, the disclosure is not limited to a standard replaceable utility knife blade.

The disclosed blade is similar in shape and material to standard hooked blades, but includes serrations to help move the material being cut (typically roofing shingles), so that the edge of the blade remains sharp for a longer period of time than conventional hooked blades. In particular, the serrations move material away from the leading edge of the blade, thereby keeping the edge cleaner and providing a longer usable blade life.

The serrations cause the disclosed knife blade to outperform conventional plain knife edges for several reasons. First, when the user starts a cut, they are effectively putting just the points of the serrations on the material, resulting in more localized pressure at those points than a plain edge, which means better penetration into the material. For example, where even a sharp plain edge might skitter across the top of roofing tiles, serrations bite in deeply.

Next, each serration acts as a mini-hook blade, forcing the material to be cut into the curve instead of pushing it away. In addition, since the serrations of the disclosed blade are chisel-ground into the blade, they can be at a lower, higher-performance angle than a typical plain edge. Serrations can sustain a very low edge angle because the points tend to protect the scallops. The penetrating points and scallops greatly assist in cutting. They tend to grab fibers and force them against the cutting surface, making it easier to cut tiles, tar paper, rope and different types of cloth, etc. The disclosed blade also stays sharp longer because there is much more cutting surface than with a regular “straight” blade. This also contributes to their superior cutting power (serrations generally tend to perform well cutting hard materials).

Still further, the combination of all of the above features of the disclosed blade; i.e., low edge angle, scallops acting as small hook blades, and penetrating points, results in the geometry of the hook maintaining a cutting edge longer than a conventional plain edge.

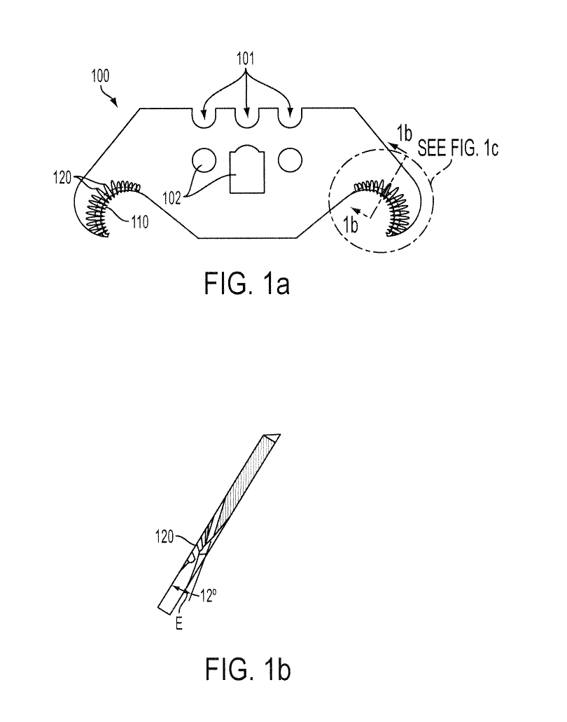

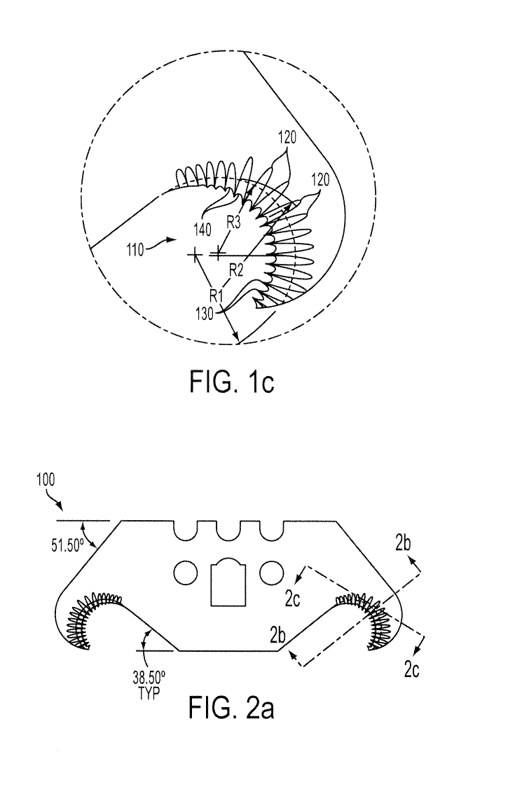

Referring now to FIGS. 1a-c, showing an exemplary embodiment of the present disclosure, a hook-shaped knife blade 100 has a curved sharpened inside edge 110, the sharpened edge 110 comprising a plurality of serrations 120. The blade 100 has notches 101 and holes 102 so it is usable with a standard utility knife or roofer's knife (not shown). Serrations 120 abut each other to form a plurality of points 130 where adjacent serrations 120 abut, and each serration 120 has an arc-shaped scallop 140 forming a portion of the sharpened edge 110. As shown in FIG. 1c, at least one of the scallops 140 has a substantially semicircular portion.

As also shown in FIG. 1c, the sharpened edge 110 has a circular arc-shaped portion, as shown by R1, R2, and R3.

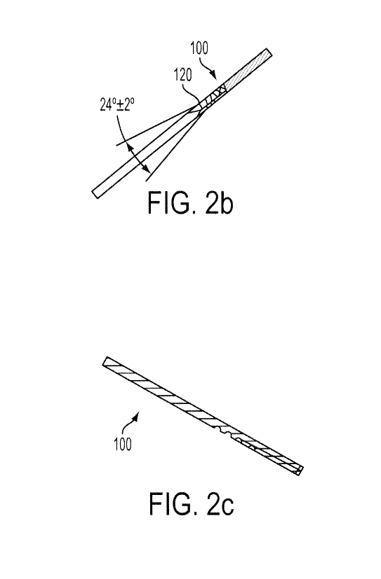

All the serrations 120 are disposed on one major surface of the blade 100. Referring now to FIGS. 2a-c, blade 100 has a thickness T, and the serrations 120 each have a depth D of less than half the blade thickness. For example, as shown in FIGS. 2b-c, the serrations 120 each have a depth D of approximately 40 percent of the blade thickness T (that is, thickness T is 0.025″, and depth D is 0.010″).

Referring now to FIGS. 1b and 2b, the serrations 120 have an edge angle E of about 12 degrees.

The knife blade shown in the drawings is for cutting roofing materials, such as shingles and tar paper, etc. However, it should be understood that the disclosed blade can be adapted for cutting other materials as well by those skilled in the art.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present teachings. However, it should be recognized that the present teachings can be practiced without resorting to the details specifically set forth. In other instances, well known processing structures have not been described in detail, in order not to unnecessarily obscure aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A hook-shaped knife blade having a curved sharpened inside edge, the sharpened edge comprising a plurality of serrations.

2. The knife blade of claim 1, wherein the plurality of serrations abut each other to form a plurality of points where adjacent serrations abut.

3. The knife blade of claim 2, wherein each serration has an arc-shaped scallop forming a portion of the sharpened edge.

4. The knife blade of claim 3, wherein the sharpened edge has a circular arc-shaped portion.

5. The knife blade of claim 3, wherein at least one of the scallops has a substantially semicircular portion.

6. The knife blade of claim 3, wherein the serrations are all disposed on one major surface of the blade.

7. The knife blade of claim 6, wherein the blade has a thickness, and the serrations each have a depth of less than half the blade thickness.

8. The knife blade of claim 7, wherein the serrations each have a depth of approximately 40 percent of the blade thickness.

9. The knife blade of claim 1, wherein the blade is adapted to be usable with a standard utility knife or roofer's knife.

10. The knife blade of claim 6, wherein the serrations have an edge angle of about 12 degrees.

11. The knife blade of claim 3, wherein the blade is for cutting roofing materials.
